(19) United States
(12) Patent Application Publication
(10) Pub. No.: US 2020/0371420 A1
(43) Pub. Date: Nov. 26, 2020

(54) ENTERTAINMENT PRESENTATION SYSTEMS AND METHOD

(71) Applicant: Interesting AV Limited, Olney Buckinghamshire (GB)

(72) Inventors: Richard Paul Wood, Olney Buck (GB); Richard Wawman, Maidenhead Berkshire (GB)

(21) Appl. No.: 16/764,789

(22) PCT Filed: Nov. 14, 2018
(86) PCT No.: PCT/GB2018/053301

§ 371 Date: May 15, 2020

(30) Foreign Application Priority Data
Nov. 16, 2017 (GB) 1718977.0
Jun. 20, 2018 (GB) 1810097.4

(51) Int. Cl. G03B 21/56; G06F 3/01; G06T 13/20; G06T 13/40; G06K 9/00

(52) U.S. Cl. CPC G03B 21/56; G06F 3/017; G06K 9/00335; G06T 13/40; G06T 13/205

(57) ABSTRACT

An image projection apparatus comprising a frame structure having first and second opposing panels (6, 8) and a further panel (26) extending between the opposing panels (6, 8) and defining an opening, the frame structure supporting at least one image projection device (10, 12) mounted to the frame structure and arranged for front-projection of an image onto a gauze scrim ((14) covering the opening, and one or more reflective surfaces ((22, 24) mounted to the opposing panels (6, 8) of the frame structure and extending rearwardly. Also disclosed is a system (40) and method of presenting live entertainment comprising projecting a computer-generated image onto a surface (46), electronically driving in real time the projected image and controlling the projected image by way of an operator (52) hidden from one or more viewers (54) of the projected image, the operator (52) able to produce a reaction from the projected image in relation to an action of the one or more viewers (54).

This invention relates to a live entertainment presentation system and to an image projecting apparatus and to the front projection of overlapping 3-dimensional holographic-type images.

Many known apparent aerial image projection arrangements use rear projection to display an image from a projector device onto a screen, and in particular onto a semi-transparent screen or scrim of a net-like or gauze-like structure. This category of structure may include one that is heavily perforated to give a similar hole to reflective surface ratio as an effective scrim net or gauze. There are also similar structures that are transparent with some light diffusing material associated with the surface that behave in a similar manner. However, rear projection of images onto a scrim or these other similar structures suffers from a big problem of hotspots on the scrim, namely those areas of the displayed image nearer the projection device appear brighter than those areas further away, so that there is often a noticeable degradation in the quality of the displayed image.

Many apparent aerial projection arrangements, for example, projection onto a gauze or scrim, the popular Peppers ghost illusion or other holographic-type illusionary images that place a virtual image forwardly of a structure all have their content made by simple methods of standard filming and post production techniques, such as those disclosed in WO2010/007420. Such techniques and similar greenscreen procedures are well known and create holographic-type illusion content that is played back sequentially from a time line on a standard media player/server or PC.

Content containing images of famous individuals, past and present, for instance can be created using body doubles and look-alike actors and, to some extent, more complex software manipulation of “rigs”, i.e. a wireframe of large numbers of polygonal shapes with a texture application that are added later during a post-production process. A well-known example is the artist's Tupac “holographic illusion” at Coachella in 2012. These rigs can be produced easily on creative software platforms like “Unreal Engine” (Registered Trade Mark).

One problem with the play-back of all these standard types of solution is that they all follow a pre-set routine in that they will create content that starts at one point and like a film plays out the content as it has been recorded, edited and laid out. In a live event situation, this procedural play-back limits the believability of the event. Interaction between the holographic-type image and a viewer or an audience is not possible.

One way to create content for a digital resurrection of a dead artist is to film a body double performing the original artist's work set against a black or green background using a single camera in a locked-off and fixed position. Captured images produced this way are then luma- or chroma-keyed so that the subject can be presented on a black background. Then a realistic digital wireframe construction of the artist's face is crafted from multiple photographs from multiple angles. A digital facial reconstruction that works in conjunction with the body double can then be created and digitally “stitched” to the canvas with the filmed content. Operation of the face of the artist image is achieved by a real person's facial movements as recorded via an infra-red camera that views the actor's face in close-up. On the actor's face there are a series of IR reflective nodes which when illuminated with IR light from the front sides and above positions produce depth and spatial cues to the computer hosting the wireframe model. Changes in the actor's facial expressions and movement of the mouth and eyes are transferred to the wireframe construction. Then in post-production, the wireframe is rendered with a digital skin with appropriate textures and colours. In more advanced systems, as will be disclosed hereinbelow there is the option to use visible light camera images and depth perception algorithms to produce a similar facial tracking model.

One major problem with this technique is that the linking of the digital head and the filmed body can look disjointed and unnatural.

According to one aspect of the present invention, there is provided an image projection apparatus comprising a frame structure having first and second opposing panels and a further panel extending between the opposing panels and defining an opening, the frame structure supporting at least one image projection device mounted to the frame structure and arranged for front-projection of an image onto a gauze scrim covering the opening, and one or more reflective surfaces mounted to the opposing panels of the frame structure and extending rearwardly.

Owing to this aspect of the invention, a relatively small mobile unit for front projection of a realistic holographic type image can be provided.

Advantageously, there are first and second projector devices, preferably ultra short-throw projection devices, for front-projection of respective overlapping images onto the gauze scrim. In addition, there is also provided a data processing device connected to the first and second projection devices for performing blending of the overlapping images so that a single image on the scrim is viewed by a viewer through the opening.

Furthermore, the at least one projector device is preferably arranged to project the image in a portrait orientation rather than a landscape orientation. In addition, different lenses and different projector positions can also be considered.

Advantageously, ultra short-throw projector devices are used which are laser projector devices. Alternatively, standard lamped projectors that are able to take lamp arrangements modified to allow the portrait orientation of the projector could also be used. The projector devices may be arranged on their side edges, i.e. rotated through 90 degrees, within the frame structure to achieve projection of an image in portrait orientation on the scrim. In one embodiment of this present invention, the projector devices have ultra-short throw lenses which facilitate the positioning of the projectors close to the scrim net gauze or similar structure, further enhancing the advantage of a compact unit.

The reflective surface(s) are preferably black reflective surfaces.

The data processing device is advantageously a media server or a PC, which includes software capable of soft edge blending of images in a portrait orientation.

According to a second aspect of the present invention, there is provided apparatus comprising a frame structure having first and second opposing panels and a further panel extending between the opposing panels and defining an opening, the frame structure supporting first and second illuminating devices mounted to the opposing panels and arranged for crossed front-illumination of a subject located in the opening, a first image-capturing device for capturing images of the subject using electromagnetic radiation in the visible spectrum and a second image-capturing device for capturing images of the subject using electromagnetic radiation in the invisible spectrum, images captured by the second image-capturing device being in isolation from any motion or changes in images captured by the first image-capturing device.

Owing to this aspect of the invention, an image acquisition apparatus can be provided in which visible light projected from the front-illuminating devices can be controlled, by way of the second image-capturing device, to fall upon the subject and not areas behind the subject.

According to a third aspect of the present invention, there is provided a semi-transparent screen comprising a gauze-like structure having a front surface upon which an image is projected, wherein the front surface includes a first zone and a second zone, the first zone having a greater reflectivity than the second zone, the image being projected arranged to fall within the first zone.

Owing to this aspect of the invention, a gauze screen being virtually undetectable by a viewer of the image whilst providing a sufficient reflective nature to produce a good quality image can be provided.

Advantageously, in one embodiment of this present invention the second zone where the image does not appear will be as black as possible and therefore absorbing of the ambient light on a viewer's side. It will also be of a transparent holed construction that allows light from the rear setting to be apparent to the viewer in a natural way. By such means the material will in effect disappear from the observer's view.

Advantageously, the first and second zones are distinguished by colour, the first zone being preferably of a grey colour and the second zone being black, although other colours would be possible depending upon the precise nature of the use of the screen. A fading of colour from one region to another is also preferable.

According to a fourth aspect of the present invention, there is provided a live entertainment presentation system comprising a projection device for projecting a computer-generated image onto a surface, the image being electronically driven in real time by way of an operator hidden from one or more viewers of the image, the operator able to produce a reaction from the projected image in relation to an action of the one or more viewers.

According to a fifth aspect of the present invention, there is provided a method of presenting live entertainment comprising projecting a computer-generated image onto a surface, electronically driving in real time the projected image and controlling the projected image by way of an operator hidden from one or more viewers of the projected image, the operator able to produce a reaction from the projected image in relation to an action of the one or more viewers.

Owing to these aspects, a four-dimensional entertainment presentation system can be provided in which a projected image can fully interactive with a live audience.

In order that the present invention can be clearly and completely disclosed, reference will now be made, by way of example only, to the accompanying drawings, in which

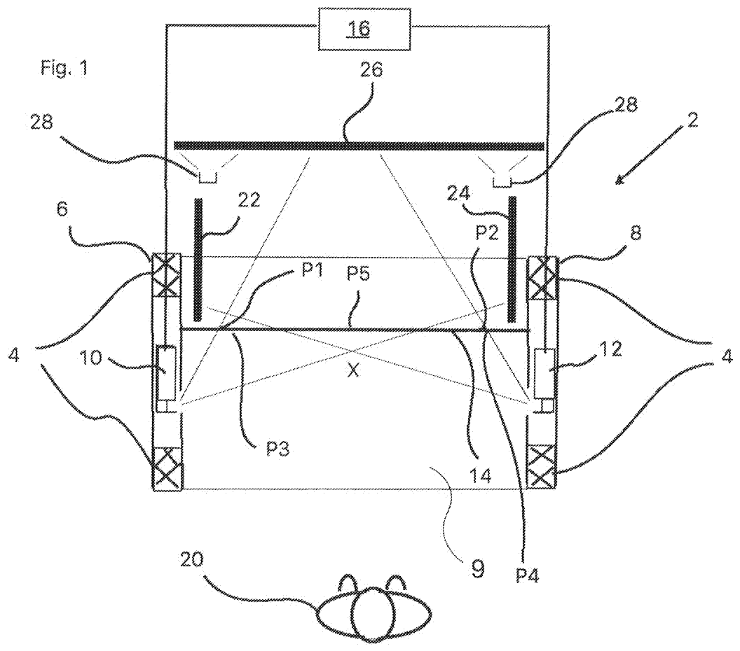

FIG. 1 shows in schematic plan view an image projection apparatus in a content projecting mode,

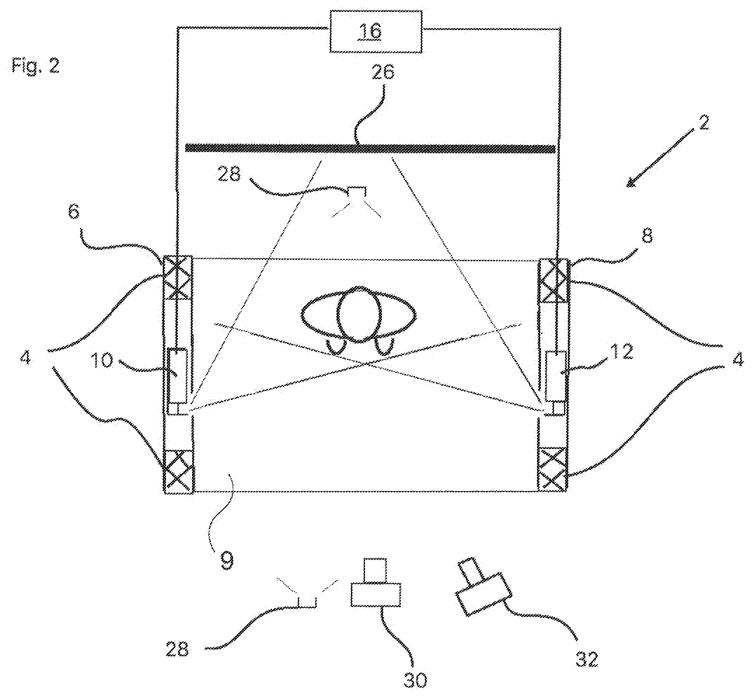

FIG. 2 is of the apparatus of FIG. 1 but in an image acquisition mode, and

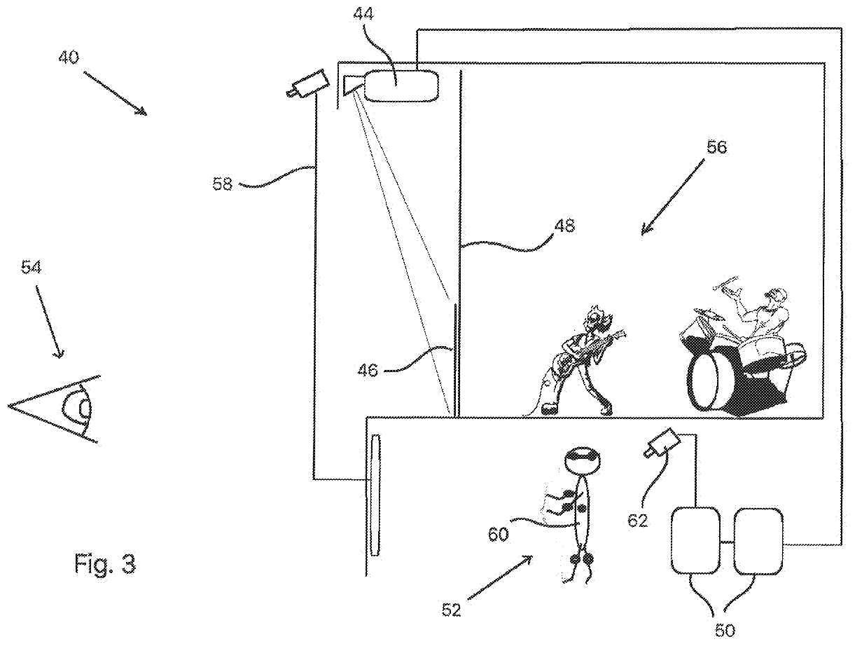

FIG. 3 shows a schematic view of one preferred embodiment of a live entertainment presentation system.

Referring to FIG. 1, an image projection apparatus 2 comprises a frame structure 4 including opposite side panels 6 and 8 separated by a roof panel (not shown) extending between the side panels 6 and 8 and defining an opening. A first short-throw preferably laser-based illumination projection device (although other lamped projectors with appropriate portrait enabling modifications also work) 10 and a second short-throw preferably laser-based illumination projection device (although other lamped projectors with appropriate portrait enabling modifications also work) 12 are mounted to the respective opposing side panels 6 and 8 and arranged on their side edges so as to project an image in portrait format as opposed to the regular landscape format when the projector devices 10 and 12 are placed with their base resting upon a surface and also hidden from a viewer 20. Projector devices 10 and 12 are arranged in front of a semi-transparent gauze scrim screen 14 arranged substantially vertically to cover the opening of the frame and upon which the projected images from the projector devices 10 and 12 are displayed in an overlapping relationship. Thus, the images projected for display on the scrim 14 are front-projected images. The projector devices 10 and 12 may project identical images that overlap on the scrim 14 or they may project different respective first and second image parts which have an overlapping portion to make a single displayed image.

The scrim 14 may be stretched tight and attached to the frame 4 or it can be independently supported on a further frame and arranged such that the scrim 14 covers the opening of the frame 4. Arrangements where the scrim 14 can be retracted to allow personnel movement through the apparatus are also possible. These can be rapid removal mechanisms when the apparatus is used, for example, as the basis of a magician's trick or simpler and slower mechanisms that free up the space to allow filming of subjects in the space as described later.

A data processing device 16 in the form of a media server or a dedicated PC is connected to the projector devices 10 and 12. The data processing device has the image to be displayed stored in its memory and also includes image processing software capable of carrying out soft edge blending of the portrait images where they overlap such that one high-definition image is viewed by a viewer 20 through the opening of the frame 4. This software manipulates the images so that there is pixel matching and image warping in order that the two images can be overlapped in a seamless way. The image processing involves, in the areas of the overlap, fading down one of the images and enhancing the other to achieve the desired result.

The scrim 14 is a semi-transparent screen of a fine gauze and, in use, is invisible to the viewer.

Where the images projected are identical, there is a large area of overlap of the images. Referring to the drawing, light emanating from the first projector device 10 is cast on the scrim 14 from a proximal point P1 closest to the projector device 10 and a distal point P2 furthest from the projector device 10. Similarly, the second projection device 12 casts light on to the scrim 14 from a proximal point P4 closest to the projector device 12 and a distal point P3 furthest from the projector device 12. At point P1/P3, the image that appears on the scrim 14 is 100% from the first projection device 10. Progressing inwardly of the scrim 14 the composition of the image gradually changes until at the mid region P5 the image viewed is made up of 50% from the first projection device 10 and 50% from the second projection device 12. At point P2/P4 the image that appears on the scrim 14 is 100% from the second projection device 12. Under certain circumstances, there may be a swapping of the 100% illumination positions.

The apparatus 2 further comprises two reflective surfaces 22 and 24 arranged laterally behind the scrim 14, slightly inwardly of rearward portions of the opposing side panels 6 and 8 behind the scrim 14 and extending rearwardly towards a black background surface 26. The reflective surfaces 22 and 24 are advantageously black reflective panels, and may be solid panels or flexible that can be provided in roll-form but unrolled and fixed in a planar form. The black reflective panels and the black background give ideal contrast between the projected image and the area behind the scrim 14 from the point of view of the viewer. These specular reflective surfaces can be set up at different angles to perfect the illusion.

Each projection device 10 and 12 will, owing to the semi-transparent nature of the scrim 14 produce a secondary image at a location rearwardly of the scrim 14, where projected light from the projection devices passes through the gauze structure of the scrim; i.e. the projected light which is not reflected back to the viewer 20. The presence of a secondary image is very problematic in creating realistic projected images because if the viewer is able to see the secondary image on a surface behind the scrim 14, then the 3-dimensional holographic-type illusion is destroyed. The preferably black reflective surfaces 22 and 24 deal with the secondary images by reflecting them away from the viewer and directing them further rearwardly of the apparatus 2 where the secondary image is much weaker by travelling further and when it eventually lands on another surface it is largely absorbed by the black background and so becomes virtually invisible to the viewer. The specular or mirror-like reflective properties of the surfaces 22 and 24 ensures that the unwanted secondary image is not viewed by any scattering of light in all directions as would happen on a matt surface. The reflectivity of these surfaces is characteristically different to that of the scrim surface in that the reflectivity of the scrim component is defined as a diffusive reflectivity which scatters the light in a manner approximating or tending towards the characteristics of a Lambertian surface. Advantageously, the specular reflective surfaces 22 and 24 can be positioned close to the rear of the scrim 14 or net and any projected image that passes through the holes of the scrim that are there for reasons of transparency can be redirected away from the view of the viewer. Such reflections are easier to over-power with the stage or set-work lighting and/or be absorbed by black drapes. The reason for this is that the projected light expands the area it covers the further it travels from the projector device. In doing so the intensity of the projected image is reduced the further it travels away from the projector device. The preference for a black specular reflective surface is that it enhances the contrast of the desired image in some off-centre viewing positions. However, other non-black specular versions of these reflecting surfaces can be used to good effect.

The present invention is particularly useful as relatively small-scale display units at events such as exhibitions where several viewers can look through the opening and see a virtual 3-dimensional holographic-type image which could even be interacted with by a real person located behind the scrim 14 or similarly in front of the scrim 14 at point X.

Some selective lighting 28 is arranged to illuminate the black background surface 26 for depth perception.

The images or content to be displayed are preferably moving images, the content normally being pre-recorded and run through the memory of the data processing device. Sometimes the content can be a feed from a live second location. Advantageously, the content does not have to be recorded in a studio, but can simply be from a repositioning of the components of the display and a suitable camera that can record 2K or 4K video content in full frame format featuring full pixel readout. In addition, the camera advantageously has very good light sensitivity in the visible electromagnetic wavelength spectrum, using, for example, a full frame CMOS sensor for advanced light capture. Such a camera set-up has a lower density of pixels in the output than is technically possible. The trade-off is that each pixel sensor is not crowded in or shadowed by other pixel light sensing components and the result is a camera sensor that will perform in very low light levels even with 4k video output. Thus, even though the light levels may not be equivalent to those in a studio, the result is the same and thus such a suitable camera is extremely economical in terms of equipment required and also in personnel to operate it. Current professional cameras that are regularly used to capture content for these types of holographic illusions use CCD sensors and are generally 10 times more expensive to purchase. Until now this investment meant that the commercial solution to produce content for Holographic type illusions was to rent in a professional photographer and his/her equipment. This apparatus allows the content to be produced with much less skill and investment.

It can be advantageous that interaction between the projected image and a real person located behind the scrim 14 takes place to improve the immersive 3-dimensional impression given. The scrim 14 needs to be semi-reflective in order to allow the image to be reflected back towards the viewer whilst the remainder of the projected light travels through the scrim to behind the scrim 14 to produce the already mentioned secondary image. The scrim 14 also needs to appear to be invisible to the viewer otherwise the apparent 3-dimensional effect of the image would be completely lost. Black scrims against a black background are ideal at appearing invisible to the viewer but are not good at reflecting sufficient projected light to produce a bright and sharp projected image. The scrim 14 may have a first zone, preferably of a grey colour, upon which the image is to be projected and could even possibly be sized and shaped to correspond with the projected image and which would usually be in a central region of the scrim, with the remainder or second zone of the scrim being black. These two different zones of the scrim are preferably produced by having a grey coloured scrim which then has the necessary areas sprayed or dyed black. When presented in an appropriately lit scene, grey scrims are found to be extremely good at being virtually undetectable by the viewer whilst providing a sufficient reflective nature to produce a superior quality image. In this way, the viewer finds it extremely difficult to visually detect the scrim and thus provide a very immersive experience for the viewer.

The second zone where the image does not appear should be as black as possible and therefore absorbing of the ambient light on a viewer's side. It will also be of a transparent holed construction that allows light from the rear setting to be apparent to the viewer in a natural way. By such means the material will in effect disappear from the observer's view. The first zone which is a diffusive reflective zone where the image will appear will be constructed similarly with enough holes to allow the setting behind to be seen. This transparency so renders the gauze screen material close to invisible in the correct lighting conditions. The use of a white or, preferably, grey colouration to the first zone improves the quality of the image being projected although other colours may work in certain circumstances, e.g. a pink scrim with a red background to the setting behind. Since it is not possible to project black onto a white or grey surface; black being the absence of light and it is not possible to project the absence of light, any projected content that has a large amount of black in it will need to be set-up such that there is a sympathetic background of predominantly black objects or curtains to a rear wall. Under this circumstance, the viewer's “mind's eye”, fills in the black at the screen surface where the content is actually displayed even though it might be getting the black cue from a metre or so away from the screen surface.

A further advantage of the apparatus as shown in FIG. 1 is that it can double as an effective portable studio for the production of content to be subsequently projected on to the scrim 14 in the apparatus 2, as shown in FIG. 2. This is achieved by simply removing the scrim 14 or gauze or equivalent structure from the framework (and potentially a ceiling panel when present) and the reflective surfaces 22 and 24. In this image acquisition mode, the projector devices can be used to light the subject to be filmed in an appropriate manner that can be captured by a first image-capturing device using electromagnetic radiation in the visible spectrum, such as a camera 30, for example, the full frame CMOS light-sensitive camera described earlier. The projector devices 10 and 12 are arranged to provide side-lighting that makes these types of illusion work well when subsequently projected and the camera 30 can very effectively capture the subject positioned in the cross-projected light of the projector devices. Further enhancements can be made by increasing or decreasing the area of soft-edge blend which takes place subsequent to the filming or by changing colour of the light used to illuminate the subject. Electronic templates of effective projected light fields can be pre-prepared and stored on the media server 16 in a way that optimises the light directed to the subject and minimises the light projected past the subject. This is an advantage over standard studio lights which only use physical barriers like “barn door” attachments to make these types of masks. The lights 28 used to illuminate the rear of the set-works when the system is in projection mode rather than image acquisition mode can be re-purposed and re-positioned to further improve the lighting in a traditionally multipoint or even classic three-point light set up as appropriate, thereby supplying the appropriate fill to complement the side lighting effect from the projected light. Advantageously, the repositioning of the lights 28 that would otherwise illuminate the scene behind the virtual image in the image projection mode means that the resulting unlit box becomes a very effective dark cave which further enhances the isolation of the filmed subject, the colour temperature of the lights used to film with is also then captured in the filmed content and replicated in the final display. Further colour temperature adjustments in the modern cameras described also further assist in this matter in a way not previously conceived.

A further enhancement of this image acquisition arrangement can be achieved by using a second image-capturing device for capturing images of the subject using electromagnetic radiation in the invisible spectrum, such as a camera 32 pointed at the subject, this additional camera 32 being set up to detect only light in the infrared spectrum. The additional camera 32 can then detect the motion of the subject in isolation from any motion or changes in the projected light content; the subject being for example, a person stood talking and moving their hands. The output data from the infrared camera 32 can then, by simple computer algorithms, be appropriately modified to ensure the visible light projected by the projector device(s), hits the subject but not projected onto the area behind the subject. This is a beneficial way of acquiring video footage that isolates the subject against a black background.

The content generated by this image acquisition mode can be reproduced in any of the popular holographic illusions such as the popular Peppers ghost arrangements or even those based on forward projecting image displays based on curved mirrors.

The apparatus described herein can be used to display content from many different image capturing devices such as teleconference cameras; from live cameras; from motion capture devices working avatars hosted on a computer and like other apparent aerial projection systems the fact that the image appears within the apparatus means that people can interact with the content in imaginative and exciting ways. One way is to utilise another infrared camera aimed at the subject and augment the reality by overlaying content, for example, a CGI-generated image, such as a set of armour and when the person moves, the CGI-generated content is triggered to do the same and so the illusion that the person is wearing armour is achieved from the viewer's position. Another setup with the cross-projection arrangement of two projector devices means that a physical person can approach the rear of the scrim 14 very closely without the secondary unwanted image appearing on their body. Additional well focused side and top lighting of the real person has to be well directed and shuttered so as not to illuminate the surface of the scrim 14.

Advantageously, the fact that there is a position close to the rear surface of the scrim 14 where there is no projected light means that a further camera can be placed behind the scrim where a person's head appears in the content projected. Such an arrangement can allow for the masking of the further camera position and allow true eye-to-eye contact between a person in an identical second apparatus in image acquisition mode in another location. This set up is improved by covering the further camera and any support structure in black light-absorbing material. Vantablack is a very effective commercially available solution but also ordinary matt black material can work well provided the unit is placed out of the projected light-paths. Another solution is to again use the specular reflective surfaces to hide the camera and its structure.

The transmission of data between the sets of apparatus could be enabled by standard teleconferencing codec or live outside broadcast methods. Advantageously this can also be achieved with lossless codec systems that have been developed in recent years and these could also be transmitted via bonded mobile phone units that are able to provide high band width internet over a mobile telephone network. This arrangement further enhances the number of locations that such apparatus could be positioned and further reduces the cost for such apparatus over traditional methods of achieving the same.

The apparatus with or without the additional teleconferencing or augmented reality arrangements can be mounted onto the back of vehicles such as a lorry and then used to entertain at events with apparently a live performer on the stage. Additionally, the apparatus could make very cost-effective systems for persons to hold discussions such as it would allow politicians to host virtual hustings in multiple locations. Such events have been delivered in the past but using much more costly techniques.

Aside from the visual aspects, another important feature of the apparatus is audio-related.

Audio signals can be captured (in the image acquisition mode) and reproduced (in the content-projection mode) using standard audio equipment or, advantageously, by the use of microphone arrays and directional speaker systems which can be employed to enhance the content, particularly when the content has people speaking. This sort of audio system has the benefit that the audio content can be confined to a zone or frequency range that does not annoy people in a nearby location to the apparatus but not actually engaging with the apparatus. An example might be if the apparatus were placed in a hotel reception to meet and greet guests then the audio content might get to be very irritating for employees in the same area, even though the guests are only hearing the content for the first time. Such audio systems are able to adjust their output according to the ambient noise, achieved by sampling the ambient noise via a microphone at the location and correspondingly adjusting the output of the speakers to match the environmental audio level. Thus, a person might be softly spoken in a quiet environment but speak more loudly for the audience to hear as the background noise levels rise.

The fact that the scrim 14 is full of holes (owing to its gauze structure) means that it is also transparent to audio signals. Therefore, the speakers can be positioned on the opposite side of the scrim 14 compared to the viewer. Advantageously, the speakers can also be positioned directly behind where a projected person's head would be positioned thus producing the perfect location for the voice from the projected person to emanate from, enhancing the realism of the displayed content. Such a speaker location would need to have the same black camouflage treatment as describe for the teleconferencing camera above.

Further modifications could be made to the audio system to enhance realism. One modification being the addition of an audience facing camera which is able to detect how far away the audience is stood from the apparatus. This modification would thereby adjust the volume according to the distance in a manner that is representative of how a person raises their voice to engage with someone who is further away than someone who is closer. Such a system would trigger only if the person in the mid distance was looking at the apparatus and this knowledge can be achieved by use of facial recognition software that can detect the direction a person is looking.

Such facial recognition software can also be utilised to recognise regular customers or VIPs entering a location such as a store or a Hotel and would allow the apparatus to appropriately name and engage with the recognised person.

The addition of an appropriately located microphone system to sample audio input of the person intending to interact with the apparatus will also enable the interface with an artificial intelligence (AI) hosted on the server or internet. A typical interaction with this system might be that a guest to a hotel might approach this apparatus in the location where a receptionist might be located. The guest might for example be Arabic and when he or she starts to talk the machine learning AI system detects the language and appropriately switches the output audio signal to be selected from the Arabic section of the AI system at the same time the virtual receptionist might switch to a culturally sensitive representation, for example, the video content projected would be of a man that is dressed in traditional Arab attire so offering a custom welcome for all guests.

The apparatus can very effectively be coupled with a motion capture system that feeds movements of an actor in a different location to the media server in such a way that these movements are interpolated by software in the media server and then they trigger the movement of an avatar projected onto the scrim 14 in a similar manner. In such a way a hidden actor can operate, for example, an image of an animal (possibly a fantasy creature) that appears as projected content. The creature could thus engage in real-time conversation with someone at the apparatus by using a microphone, the speakers and camera feed to the remote location where the actor is and by the use of a microphone and speaker system in the remote location with the actor. Such an apparatus would be very effective at getting people to engage with the projected content.

Often this type of apparent aerial projection apparatus is called holographic projection. Such a description is considered inaccurate by most academic sources. The main reason for this is the fact that the image that is produced in this type of apparent aerial projection system whilst quite convincing has associated with it a weakness in that the content is only created in a 2D plane whereas true holographic images capture a z plane as well as the X and Y plane. In a true holographic image, it is possible to stand to the left of the image centre and view into the volume captured by the holographic medium and a viewer can observe for example the left-hand side of an object but not be able to see the right-hand side of the object until they moved to the right-hand side whereupon they are able to see the right hand side of the apparent object but not the left-hand side of the same apparent object. With most aerial projection apparatus or holographic illusions, the z-plane is faked by continually moving and rotating images to present to a stationary viewer different side views of the image.

In order that the apparatus operates in a way which is closer to the academic description of a true hologram, the projected content can be captured in several ways all of which are concerned with ensuring that there are many more viewing aspects available for reproduction by the display according to where the viewers are positioned. Either a camera can be moved around an object as in a 360-degree scanning process, or the subject can be rotated on a turntable with a fixed camera to offer up all the different viewing aspects. There may need to be some form of post-production “touching-up” of the content produced particularly with the first of these methods. The second of the methods tends to produce a cleaner result provided the content is filmed against a green or black background and any “keying” necessary to isolate the content to a black background is achieved. In a third method, an array of a plurality of cameras can be configured in one or many arcs around the subject to be captured. The feeds from all the cameras creates a multitude of viewing angles. It is also possible to interpolate and produce more views than are actually captured by the cameras—this is achieved using lightfield principles and associated correction algorithms.

To interrogate the large amount of data produced in the capture on these photographic methods or indeed any similar database of viewing angles that is created in CGI content, the apparatus has the addition of one or more outwardly facing cameras which are able to detect the location of the viewers' eyes. This may be by facial recognition and eye-tracking methods or it may be that the viewer or viewers have glasses with infrared reflecting tags which are detected by the outwardly facing camera(s) set to detect those light frequencies. Alternatively, RFID tags in glasses or a hat worn by the viewer or viewers can achieve a similar location detection process. By such means the viewer's eyes are located. These locations are then associated with the appropriate viewing angle in the server and once selected they are reproduced.

If only one viewer is interacting with the apparatus, then the appropriate view can be easily reproduced in that it can have the one viewer's correct viewing angle reproduced in the display in the same manner as content is usually projected. More viewers interacting with the apparatus at the same time requires for the relevant content to be simultaneously represented to the appropriate viewers. This can be achieved using projectors with the capability of reproducing images at very high frame rates. Normally 24, 25 or 30 frames per second is adequate to produce a video image that appears smooth and natural to the viewer. Special high frame rate capable projectors can allow several viewers to be presented with their own 24, 25 or 30 frames per second streams of video. These video streams each changing with the viewers change in position. To ensure that the video stream is seen at the right consistent frame rate the feeds are interlaced. For example, if there are 6 viewers and the projector is capable of 120 frames per second, then the first viewer is presented the first frame, the 2nd the 3^{rd} and so on until the 6^{th} viewer has been presented their first frame of the video. Then the next frame is the first viewers and this repeats around the viewers in this manner until the end of the video stream. However, such a video stream is actually not viewable without the other five images i.e. those other than the one associated with the relevant viewer being hidden from view. This is achieved by wearing active spectroscopic glasses synchronised with the projector and media player. Such glasses shutter closed while the 5 non-relevant frames are presented and then open for the relevant frame to be viewed by the viewer.

Referring to FIG. 3, an entertainment presentation system 40 includes a projection device 44 for projecting a computer-generated image 46 onto a projection surface 48. This projection device could be, for example, a high powered a 20 k (or greater) ANSI lumen laser- or mercury-lamped projector with high or ultra-high resolution (e.g. 2 k to 16 k are currently possible, but with time this will increase). Such projectors are also selected for their ability to deliver high dynamic range and a wide colour gamut with uncompressed 4:4:4 video file types being capable of being reproduced by the projection engine. The lenses on the projector can be of any throw distance ratio or any angle of projection, and so ultra-short throw projection lenses are preferred. Advantageous ultra-short throw ratio lenses attached to high-powered projectors are capable of projecting at an extreme off-axis angle. The position of the projector can be above a viewing audience, above the stage, lower than the stage or at the stage level. Alternatively, the image 46 can be cross-stage projected with portrait-oriented or landscape-oriented projected images. The image 46 is projected onto any suitable surface, which may be organic or otherwise. For instance, the surface may be a gauze screen or scrim. Other surfaces which are transparent but also allow a projected image to resolve on the surface are also possible. These include transparent OLED screens or meshes of LEDs that can be seen through. Additionally, projected surfaces with either diffusing particles or HOE's (holographic optical elements) can be used. Furthermore, reflected image systems such as the well-known Peppers ghost arrangements are possible. Moreover, light field displays can be used to make the visual interface with the audience.

Three-dimensional (3D) computer-generated models or images represent a physical body using a collection of points in 2D/3D space, connected by various geometric entities such as triangles, lines, curved surfaces, etc. By having a collection of data (points and other information), 3D computer-generated images can be created manually, algorithmically, or by scanning. Texture mapping may be used to further define the surfaces of the image.

Almost all 3D models can be divided into two categories, namely solid or shell. Solid models define the volume of an object they represent, usually built with constructive solid geometry and are mostly used for engineering and medical simulations. Shell or boundary models represent the surface, e.g. the outer boundary of the object, not its volume, like an infinitesimally thin eggshell. Almost all visual models used in computer games and movies are shell models. Shell models must have no holes or cracks in the shell to be meaningful as a real object and polygonal meshes are by far the most suitable representation.

The process of transforming representations of objects, such as the middle point coordinate of a sphere and a point on its circumference into a polygon representation of a sphere, is called tessellation. This step is used in polygon-based rendering, where objects are broken down from abstract representations (or “primitives”) to so-called polygonal meshes or wireframes, which are nets of interconnected shapes. Such wireframe models are popular as they have proven to be easy to rasterise.

Polygonal modelling defines points in 3D space, called vertices, which are connected by line segments to form a wireframe representing the object to be modelled. The vast majority of 3D models are built as textured polygonal models, because they are flexible and because computers can render them so quickly. Other forms of representing a model include curve modelling and digital sculpting.

In the present invention, a data processing device, such as a computer, is used to create image content, by creating a very high polygon-count computer-generated image enabling the virtual subject of the projected image to be projected as a much more realistic, believable illusion compared with images from lower polygon-count solutions. Advantageously, the whole body of the subject of the image is treated as a wireframe computer model in order to avoid the need for “stitching” together of different images for the head and body. The wireframe is subsequently and crucially rendered in real time owing to a network of data processing units 50, preferably in the form of a plurality of highspeed graphic processing unit (GPU) clustered software engines or servers. Rendering in real time has the beneficial result that actions such as movements of a hidden operator 52 are immediately reproduced in the projected image 46 (described hereinbelow). Advantageously, the GPU clustered software engines or servers 50 are linked by ultra-high-speed optical or other high capacity wire based or wireless networking devices. The GPU clustered software engines or servers 50 have the image content stored on them and ensure real-time rendering of pre-prepared wireframes, which may be developed from, for example, known images of a dead celebrity who is being resurrected as a holographic-type image for a live show, but could be a representation of any person or character (which can include animals, fictional creatures or virtual robots).

The polygon-count is limited by the processing capacity of the computer, and it is possible, with the present set-up, to drive computer-generated images of at least 500,000 polygons.

The present invention brings a previously unknown realism to the projected image content that is enhanced by having the operator 52 (which may be an actor) hidden from view of a viewing audience 54, which may be one or more people. The operator 52 of such computer-generated images or avatars drives or works the virtual projected image 46 in a live manner in order to create real time reactivity between projected image 46 and audience 54. Such an operator will be in a position where they can view the audience but will not be visible to the audience (this maybe via a video link). This operator 52 (and in some case operators) is able to respond to audience behaviour or to an event that is unpredictable but nevertheless still happens at, for example, a live music concert on a stage 56. For example, the audience may chant for a particular favourite and/or famous song to be played or something unpredictable happens on the stage 56, which makes the audience act by shouting something unexpected. The operator 52 will be able to see and hear the audience via an audio-visual link 58, such as a video link and make reactive gestures and/or speak in reply, such that their gestures and voices are converted in a live manner to movements or audio that to the audience is perceived as emanating from the virtual holographic-type projected image 46 in front of them. In the case of geographic separation of the two locations, namely the stage and the location of the operator 52, the operator (who can be an actor performing live) and the audience viewed stage can be connected by highspeed networks similar to teleconferencing systems.

The use of the wireframe image which is then rendered in real time means that there is no need for a body double when re-creating the whole of a famous person as the projected image, so that the off-stage operator can just be any suitably skilled actor.

Manipulation of the image content to produce real-time reactivity is achieved by input signals received from an operator's input device 60. In one embodiment this input device is in the form of a motion capture suit. The motion capture suit can be one of several types including RFID tagged suits or more standard IR nodes observed under IR light with an IR sensitive camera 62 being the feed of the loci information. Preferably, these suits are of the type that allows the operator full body motion without causing overheating or the operator. The motion capture in one embodiment can simply be operated by operation of push buttons for simple replication not requiring full suits to mimic the action, but this may not result in the same degree of reactivity achieved with the motion capture suit.

In one embodiment of the present invention, the important nodes that relate to the polygon positions in the system can be identified using only camera recognition algorithms. This is also applicable to nodes on the face or hands. The algorithms are also capable of identifying the eye pupil position and size within the operator's own eyeballs and replicating the same within the virtual digital model.

The operator may be actively present throughout the live event or, alternatively, any responses can be pre-recorded in the system with the operator able to simply activate the system to perform the suitable pre-recoded response. A further possibility is to use an artificial intelligence system in order to predict and execute responses.

In one embodiment of the present invention there can be an additional actor or actors working a computer-generated model of solely the face or hand separately to the body movement. This might be advantageous when trying to capture fine movements in the body under a higher definition, higher sensitivity motion capture set-up, e.g. the fingers on a guitar are more realistic if they are made to operate as expected by the presentation of the audio track.

In another embodiment, audio output in the form of, for example, the voice of a subject whose image is being projected is synthesised by the artificial intelligence system that is able to sample voice patterns in a feed of the subject's audio voice samples. Such a system might be called a voice simulator or synthesiser, as the voice of an actor can be converted in real-time to that of the subject.

In a further embodiment, the audio output is synthesised by the voice simulator and is also mixed with pre-recorded responses. In this way, these pre-recorded responses are queued and replayed as appropriate, and the synthesized voice is used when no appropriate standard recorded responses are available.

The motion capture in one embodiment can be operated by operation of push buttons for simple replication, not requiring full motion capture suits to mimic the action required.

The real time rendering of information gathered and collated in databases relating to the nodal positions that drive the polygon wireframe points also has applications for the generation of non-human digital models. These might be animals in a zoo, an aquarium or in a virtual dinosaur park. The use of scanning photometry and related 360 degree camera techniques as well as information fed from medical scanners such as MRI scanners can also generate databases of virtual inanimate objects as well as animate ones like animals or people. This technology then allows the content for systems which have a virtual image positioned forwardly of the main structure to be presented in a form that could be manipulated by an interactive device. With the correct programming this bestows on the virtual image, behaviour that makes it the same as a real object but with no physical structure.

Audio signals can be captured and reproduced using standard audio equipment or, advantageously, by the use of microphone arrays and directional speaker systems which can be employed to enhance the content, particularly when the content has people speaking or singing. This sort of audio system has the benefit that the audio content can be confined to a zone or frequency range that does not annoy people in a nearby location to the system but not actually engaging with the system. Such audio systems are able to adjust their output according to the ambient noise, achieved by sampling the ambient noise via a microphone at the location and correspondingly adjusting the output of the speakers to match the environmental audio level. Thus, a person might be softly spoken in a quiet environment but speak more loudly for the audience to hear as the background noise levels rise.

The fact that the preferred projection surface 48 is full of holes (owing to its gauze structure) means that it is also transparent to audio signals. Therefore, the speakers can be positioned on the opposite side of the projection surface 48 compared to the viewer. Advantageously, the speakers can also be positioned directly behind where a projected person's head would be positioned thus producing the perfect location for the voice from the projected person to emanate from, enhancing the realism of the displayed content. Such a speaker location would need to have a black camouflage treatment in order to conceal their presence.

Further modifications could be made to the audio system to enhance realism. One modification being the addition of an audience facing camera which is able to detect how far away the audience is stood from the apparatus. This modification would thereby adjust the volume according to the distance in a manner that is representative of how a person raises their voice to engage with someone who is further away than someone who is closer. Such a system would trigger only if the person in the mid distance was looking at the apparatus and this knowledge can be achieved by use of facial recognition software that can detect the direction a person is looking.

Such facial recognition software can also be utilised to recognise other people at a location and would allow the system (in particular the operator) to appropriately name and engage with the recognised person.

The addition of an appropriately located microphone system to sample audio input of a person intending to interact with the apparatus will also enable the interface with an artificial intelligence (AI) hosted on the servers 50 or the internet.

We claim:

1. An image projection apparatus comprising a frame structure supporting at least one image projection device arranged for front-projection of an image onto a gauze scrim covering an opening of the frame structure, and one or more reflective surfaces positioned behind the gauze scrim relative to a viewer and extending rearwardly.

2. Apparatus according to claim 1, comprising first and second image projection devices for front-projection of respective overlapping images onto the gauze scrim.

3. Apparatus according to claim 2, and further comprising a data processing device connected to the first and second projection devices for performing blending of the overlapping images so that a single image on the scrim is viewed by a viewer through the opening.

4. Apparatus according to claim 1, wherein the at least one image projection device is arranged to project the image in a portrait orientation.

5. Apparatus according to claim 4, wherein the at least one image projection device is arranged on its side edge, i.e. rotated through 90 degrees, within the frame structure to achieve projection of the image in portrait orientation on the scrim.

6. Apparatus according to claim 1, wherein the one or more reflective surfaces are preferably one or more black reflective surfaces.

7. Apparatus comprising a frame structure having first and second opposing panels and a further panel extending between the opposing panels and defining an opening, the frame structure supporting first and second illuminating devices mounted to the opposing panels and arranged for crossed front-illumination of a subject located in the opening, a first image-capturing device for capturing images of the subject using electromagnetic radiation in the visible spectrum and a second image-capturing device for capturing images of the subject using electromagnetic radiation in the invisible spectrum, images captured by the second image-capturing device being in isolation from any motion or changes in images captured by the first image-capturing device.

8. (canceled)

9. (canceled)

10. (canceled)

11. (canceled)

12. A live entertainment presentation system comprising a projection device for projecting a computer-generated image onto a surface, the image being electronically driven in real time by way of an operator hidden from one or more viewers of the image, the operator able to produce a reaction from the projected image in relation to an action of the one or more viewers.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A system according to claim 12, wherein the hidden operator drives or works the computer-generated image in a live manner in order to create real time reactivity between the computer-generated image and the one or more viewers of the image.

26. A system according to claim 12, wherein the hidden operator is in a position where they can view the one or more viewers but will not be visible to the one or more viewers.

27. A system according to claim 26, wherein the hidden operator can view the one or more viewers via a video link.

28. A system according to claim 26, wherein the hidden operator can view the one or more viewers via an audio-visual link.

29. (canceled)

30. A system according to claim 26, wherein the hidden operator makes reactive gestures and/or speaks in reply to the unpredictable behaviour or event, such that their gestures and voices are converted in a live manner to movements or audio that to the one or more viewers is perceived as emanating from the computer-generated image.

31. A system according to claim 12, and further comprising an input device of the hidden operator to produce real-time reactivity.

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. A method of presenting live entertainment comprising projecting a outer-generated image onto a surface, electronically driving in real time the projected image and controlling the projected image by way of an operator hidden from one or more viewers of the projected image, the operator able to produce a reaction from the projected image in relation to an action of the one or more viewers.

47. (canceled)

48. (canceled)

49. (canceled)

50. A method according to claim 46, wherein the hidden operator drives or works the computer-generated image in a lye manner in order to create real time reactivity between the computer-generated image and the one or more viewers of the image.

51. A method according to claim 46, wherein the hidden operator is in a position where they can view the one or more viewers but will not be visible to the one or more viewers.

52. (canceled)

53. A method according to claim 51, wherein the hidden operator makes reactive gestures and/or speaks in reply to the unpredictable behaviour or event, such that their gestures and voices are converted in a live manner to movements or audio that to the one or more viewers is perceived as emanating from the computer-generated image.

54. A method according to claim 46, wherein the hidden operator may be actively present throughout a live event or any responses can be pre-recorded with the hidden operator able to simply activate a suitable one of the pre-recoded responses.

55. (canceled)

56. (canceled)

57. (canceled)
